(19) United States
(12) Patent Application Publication
(10) Pub. No.: US 2024/0304092 A1
(43) Pub. Date: Sep. 12, 2024

(54) AUTOMATED AND ENHANCED REMOTE ASSISTANCE AND FLEET RESPONSE

(71) Applicant: GM Cruise Holdings LLC, San Francisco, CA (US)

(72) Inventors: Jeffrey Brandon, Phoenix, AZ (US); Domenico Rusciano, Concord, CA (US)

(73) Assignee: GM Cruise Holdings LLC, San Francisco, CA (US)

(21) Appl. No.: 18/180,350

(22) Filed: Mar. 8, 2023

(51) Int. Cl. G08G 1/00; G08G 1/01

(52) U.S. Cl. CPC G08G 1/202; G08G 1/012

(57) ABSTRACT

A method is described and includes providing remote assistance to a vehicle subsequent to a remote assistance (RA) event, the method comprising receiving perception data generated by onboard sensors of the vehicle; receiving supplemental data generated by at least one source external to the vehicle; processing the perception data and the supplemental data using a co-simulation process for simulating an environment of the vehicle; and providing results of the co-simulation process to a remote assistance (RA) service; wherein the results of the co-simulation process are used by the RA service to determine an RA response.

### BACKGROUND

### Technical Field

The present disclosure relates generally to autonomous vehicles (AVs) and, more specifically, to techniques for automated and enhanced remote assistance and fleet response in connection with AVs.

### Introduction

An AV is a motorized vehicle that can navigate without a human driver. An exemplary AV can include various sensors, such as a camera sensor, a light detection and ranging (LIDAR) sensor, and a radio detection and ranging (RADAR) sensor, among others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Typically, the sensors are mounted at fixed locations on the AVs.

Data from onboard sensors may be provided to a remote assistance (RA) service for enabling an RA advisor to assist the AV to appropriately respond to a situation involving the AV. RA situational awareness may be limited by the field of view of the onboard sensors, in particular, cameras, as well as limitations of training, especially with regard to edge cases. Moreover, it is conceivable that there will be times at which there are more RA requests than there are RA advisors to service the requests.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate AV dispatch and operations, according to some aspects of the disclosed technology;

FIG. 2 illustrates a digital twin concept for facilitating embodiments described herein, according to some aspects of the disclosed technology;

FIG. 3 illustrates a flowchart of example operations for a conventional process of providing an RA response to an AV RA event, according to some aspects of the disclosed technology;

FIG. 4 illustrates a flowchart of example operations for an automated an/or enhanced process of providing an RA response to an AV RA event, according to some aspects of the disclosed technology; and

FIG. 5 illustrates an example processor-based system for use in implementing some aspects of the disclosed technology.

### DETAILED DESCRIPTION

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Given the numerous advantages of ride hail, rideshare, and delivery services (which services may be collectively and/or interchangeably referred to herein simply as “rideshare services” whether for a single user/passenger, multiple users/passengers, and/or one or more items for delivery) provided by AVs, it is anticipated that AV rideshare services will soon become the ubiquitous choice for various user transportation and delivery needs, including but not limited to school commutes, airport transfers, long distance road trips, and grocery and restaurant deliveries, to name a few.

As AVs become more widely used for the various passenger transportation and delivery services described above, it is anticipated that RA may become a more important component of providing such services. Accordingly, embodiments described herein enable automation and/or enhancement of RA response to an RA event through leveraging co-simulation capabilities of a digital twin, which could use the standard set of real-time and/or substantially real-time information from the AV (e.g., onboard sensor and/or camera data, location information, etc.), as well as other real-time information and data that is not immediately available to the RA operators to assess and respond to an AV RA event (e.g., traffic data, traffic light timing, visibility, weather information (including but not limited to projected movement of storms and/or precipitation), vulnerable road user (VRU) heat maps, etc.), along with full perception/motion control/path planning, which is processed in parallel external to the AV and prior to hand over to a human RA advisor. This enhanced process would likely increase the likelihood of unsticking the AV and allowing it to continue the service. As used herein, an RA event may be defined as event or situation experienced by an AV that requires the AV to seek guidance from an RA service to appropriately respond to the event or situation. An example of an RA event such an event or situation hereinafter referred to herein as an “RA event” may be a situation in which an AV is stuck behind a vehicle that may or may not be a double parked vehicle (DPV), in which case RA could be leveraged to help make that determination.

In an alternative embodiment, an output of a digital twin or other co-simulation would recommend a response to the AV without intervention of a human RA advisor. In this embodiment, the output from the digital twin co-simulation could also be used to automate the information provided to the passenger or other user (e.g., in the case of a delivery service) regarding the situation and how it is being addressed (e.g., reason for the AV RA event, the effect of the RA event on the estimated time of arrival (ETA), etc.).

Embodiments described herein may result in more effective and efficient RA services. Additionally, integration of AV path planning in a digital twin implementation would enable multiple RA responses to be tested in parallel before selecting and releasing the selected RA response to the AV. Still further, embodiments describe herein potentially enable RA workflow to be fully or semi-automated.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 110a-110e), such a collection may be referred to herein without the letters (e.g., as “110”).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y. The terms “substantially,”“close,”“approximately,”“near,” and “about,” generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV Management System

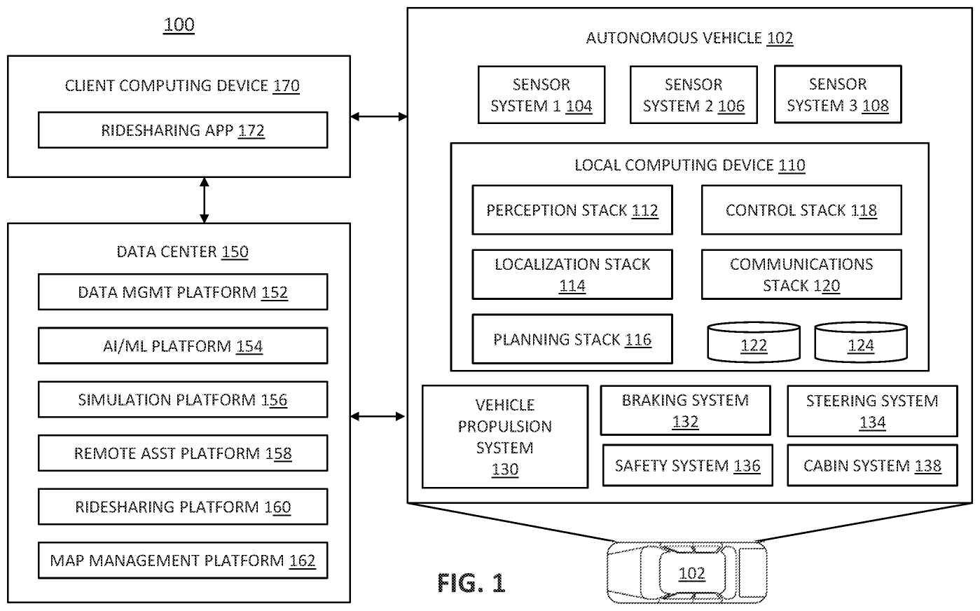

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, another Cloud

Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors. Any of the sensor systems implemented as a camera can include light (or luminance) measurement functionality.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, a High Definition (HD) geospatial database 122, and an AV operational database 124, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events.

If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

### Digital Twin Co-Simulation

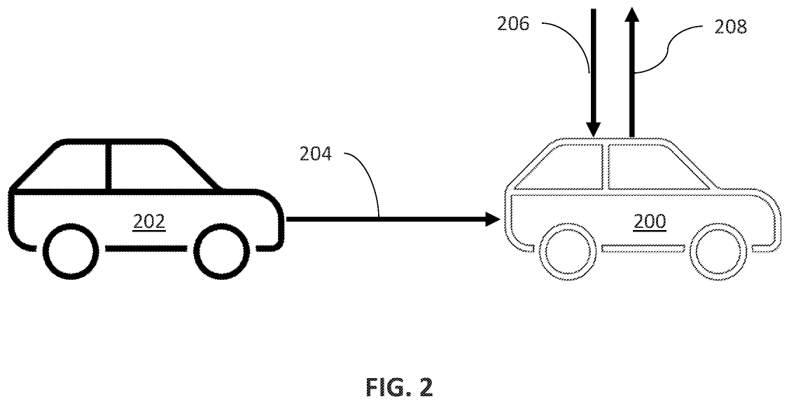

As noted above, some embodiments described herein may be implemented using a digital twin. Referring now to FIG. 2, as described herein, a digital twin 200 may be provided and is a digital representation of an AV 202 (which may be referred to in this context as a physical twin) that serves as the AVs digital, or virtual, counterpart for simulation (and in the present context, for RA scenario simulation) purposes. The AVs digital twin may be used in real time and is regularly synchronized with the AV. In particular embodiments described herein, real-time sensor and other perception data from the AV 202 is provided to the digital twin 200, as represented by an arrow 204. Additionally, other real-time data from other sources (including, but not limited to, traffic data, traffic light timing, visibility, weather information, VRU heat maps) that might be useful in assessing an RA event of the AV 202 is also provided to the digital twin 200, as represented by an arrow 206. Digital twin 200 may perform perception/motion control/path planning in parallel with the AV 202 and subsequently output information, as will be described in detail below, as represented by an arrow 208. In alternative embodiments, co-simulation techniques other than and/or in addition to a digital twin may be implemented. It will be recognized that some or all of operations of the digital twin may be performed by a computer remote from the AV (e.g., such as data center 150 (FIG. 1) or other centrally located computer to which the AV 202 is connected).

### Example Conventional Technique for Enabling an RA to Respond to an AV RA Event

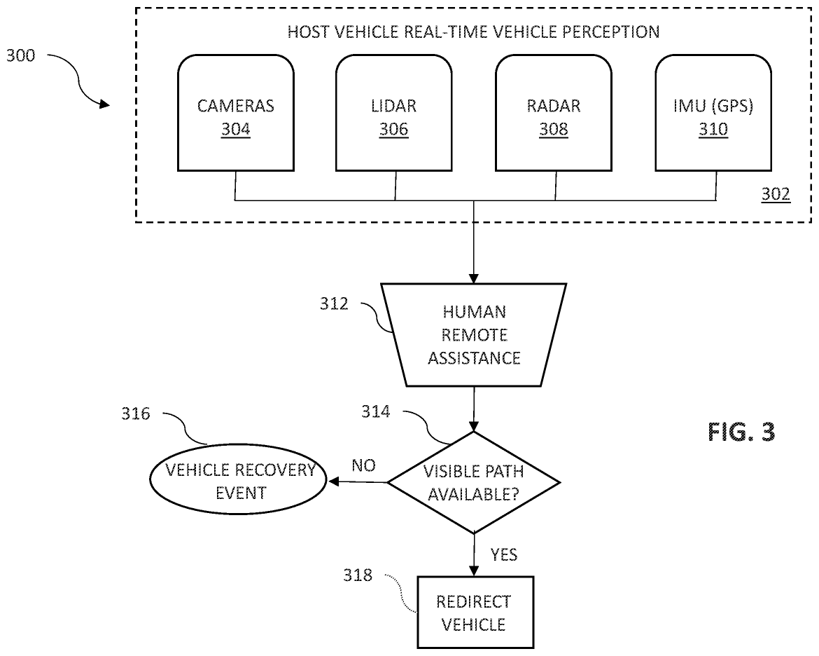

FIG. 3 illustrates a flow diagram 300 of example operations for enabling a RA response to an AV RA event, according to some aspects of the disclosed technology. In certain embodiments, one or more of the operations illustrated in FIG. 3 may be executed by one or more of the elements shown in FIG. 1.

As illustrated in FIG. 3, in response to an RA request, which may be generated in response to a RA event experienced by a host vehicle, host vehicle real-time vehicle perception data 302, which may include data from onboard host vehicle sensors, such as cameras 304, LIDAR 306, RADAR 308, and IMU (GPS) units 310, for example, is provided to a human RA advisor at operation 312.

At operation 314, the human RA advisor assesses the received host vehicle real-time vehicle perception data to determine whether there is a visible path available on which to direct the host vehicle. If at operation 314, the human RA advisor does not perceive a visible path available for the vehicle, execution proceeds to operation 316.

At operation 316, a vehicle recovery event (VRE) is initiated for the host vehicle. For example, the VRE may include towing the host vehicle to a fleet service center for further assessment, maintenance and/or repair.

If at operation 315, the human RA advisor perceives a visible path available for the vehicle, execution proceeds to operation 318.

At operation 318, the host vehicle is redirected in accordance with the path perceived by the RA advisor.

Although the operations of the example method shown in and described with reference to FIG. 3 are illustrated as occurring once each and in a particular order, it will be recognized that the operations may be performed in any suitable order and repeated as desired. Additionally, one or more operations may be performed in parallel. Furthermore, the operations illustrated in FIG. 3 may be combined or may include more or fewer details than described.

### Example Automated and/or Enhanced Technique for Enabling an RA to Respond to an AV RA Event

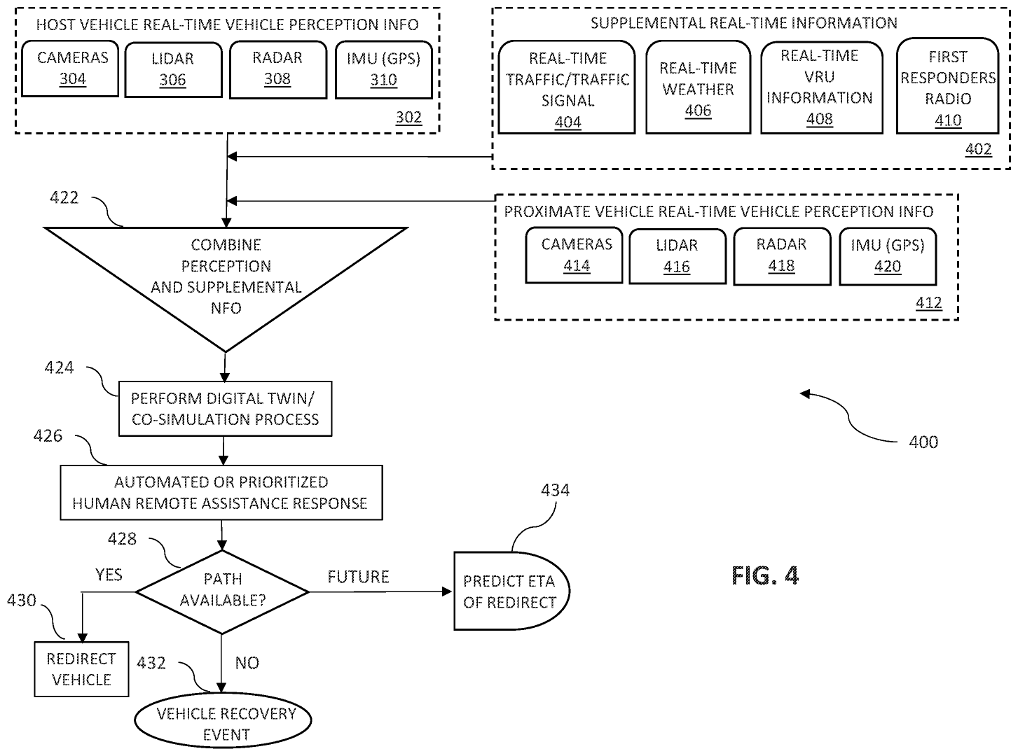

FIG. 4 illustrates a flow diagram 400 of example operations for enabling an automated and/or enhanced RA response to an AV RA event, according to some aspects of the disclosed technology. In certain embodiments, one or more of the operations illustrated in FIG. 4 may be executed by one or more of the elements shown in FIG. 1.

As illustrated in FIG. 4, in response to an RA request, which may be generated in response to an RA event experienced by a host vehicle, the host vehicle real-time vehicle perception data 302, which as previously noted may include data from onboard host vehicle sensors, such as cameras 304, LIDAR 306, RADAR 308, and IMU (GPS) units 310, for example, is combine with supplemental real-time information 402, which may include real-time traffic conditions/traffic signal information (e.g., via third party navigation application APIs) 404, real-time weather information (including visibility and/or precipitation information) 406, real-time VRU information (including pedestrian information) 408, and first responders radio information (such as police scanner information) 410, for example, at operation 422. Real-time vehicle perception information 412 from vehicles proximate the host vehicle, which may include data from cameras 414, LIDAR 416, RADAR 418, and IMU (GPS) units 420 installed on vehicles proximate the host vehicle, may also be combined with the host vehicle real-time vehicle perception information 302 and supplemental real-time information 402 at operation 422. It will be recognized that additional and/or alternative information may be combined, such as emergency scenarios (e.g., fire, storm, flood), average roadway speed (e.g., freeway vs. city/urban environment), road segment (e.g., mid-block vs. intersection vs. oncoming traffic lane (as may be the case, for example, if the vehicle becomes stuck during a double parked vehicle (DPV) maneuver)), and legal and/or regulatory limitations and/or requirements.

At operation 424, the combined host vehicle real-time vehicle perception information 302, supplemental real-time information 402, and/or proximate vehicle real-time vehicle perception information 412 may be provided to a digital twin or other co-simulation tool for processing. In particular, at operation 424, a digital twin of the host vehicle processes the received information to determine a path for the host vehicle. Because the digital twin has access to enhanced information in the form of the supplemental real-time information 402 and proximate vehicle real-time vehicle perception information 412, it can assess the situation of the host vehicle, as well as possible responses to the situation, more comprehensively. In particular embodiments, the digital twin uses the received information to perform full perception/motion control/path planning in parallel with and external to the host vehicle. The digital twin simulates various factors over time using the input information and provides ranked options, including confidence scores for each indicating the probability of success of the option.

In operation 426, information output from the digital twin is used to determine an RA response. In one embodiment, the RA response may be fully automated such that a human advisor is not needed. In this embodiment, the RA response may be fully determined by the digital twin based on the ranking and/or relative confidence score and may be provided directly to the onboard computer of the host vehicle for informing further operation of the host vehicle.

In an alternative embodiment, the output from the digital twin is provided to a human RA advisor, who further evaluates the options and provides an RA response to the host vehicle based in part on his or her judgment and/or experience. In some embodiments, the co-simulation of the host vehicle environment may be displayed to the RA advisor to assist the RA advisor in determining a response to provide to the host vehicle.

At operation 428, either the automated RA or the human RA advisor determines whether a path is available to the host vehicle; that is, a determination is made whether the host vehicle can be unstuck without requiring additional intervention.

If it is determined at operation 428 that a path to unstick the host vehicle exists, execution proceeds to operation 430, in which the host vehicle is redirected by the RA (either automatically or with human advisor intervention) in accordance with the available path.

If it is determined at operation 428 that a path to unstick the host vehicle does not exist, execution proceeds to operation 432, in which a VRE is initiated in connection with the host vehicle.

In particular embodiments, it may be determined at operation 428 that while a current path to unstick the host vehicle does not exist, a path is predicted to exist in the future, in which case execution proceeds to operation 424, in which an estimated time of arrival (ETA) of an available path is predicted based on the information output from the digital twin, for example. The predicted ETA may be provided to the host vehicle and/or a passenger within the vehicle and input may be solicited from the host vehicle and/or passenger as to whether it would be preferable to await a future host vehicle redirect or whether to initiate a VRE.

Although the operations of the example method shown in and described with reference to FIG. 4 are illustrated as occurring once each and in a particular order, it will be recognized that the operations may be performed in any suitable order and repeated as desired. Additionally, one or more operations may be performed in parallel. Furthermore, the operations illustrated in FIG. 4 may be combined or may include more or fewer details than described.

### Example Processor-Based System

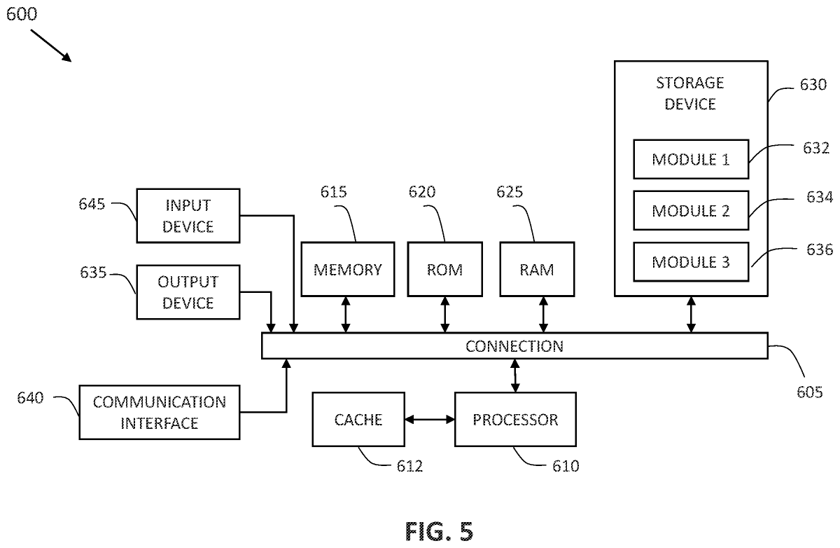

FIG. 5 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as modules 632, 634, and 636 stored in storage device 630, configured to control processor 610 as well as a special purpose processor where software instructions are incorporated into the actual processor design. One or more of modules 632, 634, and 636 may include instructions for performing one or more of operations described in connection with FIGS. 3 and/or 4. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more GNSS receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc ROM (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 provides a method for providing remote assistance to a vehicle subsequent to an RA event, the method comprising receiving perception data generated by onboard sensors of the vehicle; receiving supplemental data generated by at least one source external to the vehicle; processing the perception data and the supplemental data using a co-simulation process for simulating an environment of the vehicle; providing results of the co-simulation process to a remote assistance (RA) service determining by the RA service an RA response; and directing the vehicle to implement the RA response to the RA event.

Example 2 provides the method of example 1, wherein the vehicle comprises a first vehicle and the perception data comprises first perception data, the method further comprising receiving second perception data generated by onboard sensors of a second vehicle proximate the first vehicle.

Example 3 provides the method of example 2, wherein the second perception data is also processed using the co-simulation process for simulating the environment of the first vehicle.

Example 4 provides the method of example 1, wherein the perception data comprises at least one of camera data, light detection and ranging (LIDAR) data, radio detection and ranging (RADAR) data, inertial measurement unit (IMU) data, and global positioning system (GPS) data.

Example 5 provides the method of example 1, wherein the supplemental data comprises at least one of traffic information, traffic signal information, weather information, vulnerable road user (VRU) information, emergency information, mapping information, and legal information.

Example 6 provides the method of example 1, wherein the RA response comprises redirecting the vehicle.

Example 7 provides the method of example 1, wherein the RA response comprises a vehicle recovery event (VRE).

Example 8 provides the method of example 1, wherein the RA response comprises predicting a time at which the vehicle can be redirected.

Example 9 provides the method of example 1, further comprising advising a passenger of the vehicle of the RA response.

Example 10 provides the method of example 1, wherein the RA service comprises a human operator.

Example 11 provides the method of example 1, wherein results of the co-simulation process comprise a ranked list of options.

Example 12 provides the method of example 1, wherein the ranked list of options comprises, for each of the options, a confidence score associated with the option.

Example 13 provides a method for providing a remote assistance (RA) response to an autonomous vehicle (AV) subsequent to a determination that the AV is stuck, the method comprising processing perception data generated by onboard sensors of the AV and AV supplemental data obtained from at least one source external to the AV using a co-simulation process for simulating operation of the AV to determine a plurality of possible options for the RA response; providing the plurality of possible options for the RA response to a remote assistance (RA) service; selecting by the RA service one of the plurality of possible options for the RA response; and directing the AV to operate in accordance with the selected one of the plurality of possible options, wherein each of the options has associated therewith a confidence score.

Example 14 provides the method of example 13, wherein the supplemental data comprises perception data generated by onboard sensors of another vehicle proximate the AV.

Example 15 provides the method of example 13, wherein the perception data comprises at least one of camera data, light detection and ranging (LIDAR) data, radio detection and ranging (RADAR) data, inertial measurement unit (IMU) data, and global positioning system (GPS) data.

Example 16 provides the method of example 13, wherein the supplemental data comprises at least one of traffic information, traffic signal information, weather information, vulnerable road user (VRU) information, emergency information, mapping information, and legal information.

Example 17 provides the method of example 13, wherein the selected one of the plurality of possible options comprises redirecting the AV, initiating a vehicle recovery event (VRE), and predicting a time at which the AV can be redirected.

Example 18 provides the method of example 13, further comprising advising a passenger of the AV of the selected one of the plurality of responses.

Example 19 provides a non-transitory computer-readable medium having stored thereon instructions that, when executed by a processor of a computer, cause the computer to process perception data generated by onboard sensors of the vehicle and supplemental data received from at least one source external to the vehicle using a co-simulation process for simulating an operation of the vehicle in real-time; provide results of the co-simulation process to a remote assistance (RA) service, wherein the RA service selects an RA response from the results; and directing the vehicle to implement the RA response; wherein the onboard sensors comprise at least one of a camera, a light detection and ranging (LIDAR) sensor, a radio detection and ranging (RADAR) sensor, an inertial measurement unit (IMU) sensor, and a global positioning system (GPS); and wherein the supplemental data comprises at least one of perception data generated by onboard sensors of another vehicle proximate the vehicle, traffic information, traffic signal information, weather information, vulnerable road user (VRU) information, emergency information, mapping information, and legal information.

Example 20 provides the non-transitory computer-readable medium of example 19, wherein the RA response comprises redirecting the vehicle, initiating a vehicle recovery event (VRE), or predicting a time at which the vehicle can be redirected.

Example 21 provides a method for providing remote assistance to a vehicle subsequent to a remote assistance (RA) event, the method comprising receiving perception data generated by onboard sensors of the vehicle; receiving supplemental data generated by at least one source external to the vehicle; processing the perception data and the supplemental data using a co-simulation process for simulating an environment of the vehicle; and providing results of the co-simulation process to a remote assistance (RA) service; wherein the results of the co-simulation process are used by the RA service to determine an RA response.

Example 22 provides a method for providing a remote assistance (RA) response to an autonomous vehicle (AV) subsequent to a determination that the AV is stuck, the method comprising receiving by an RA service a plurality of possible options for the RA response, wherein the plurality of possible options for the RA response are determined by a co-simulation process that processes perception data generated by onboard sensors of the AV and AV supplemental data obtained from at least one source external to the AV to simulate operation of the AV; selecting by the RA service one of the plurality of possible options for the RA response; and directing the AV to operate in accordance with the selected one of the plurality of possible options, wherein each of the plurality of possible options has associated therewith a confidence score.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words “means for” or “step for” are specifically used in the particular examples; and (b) does not intend, by any statement in the Specification, to limit this disclosure in any way that is not otherwise reflected in the appended examples.

What is claimed is:

1. A method for providing remote assistance to a vehicle subsequent to a remote assistance (RA) event, the method comprising:
receiving perception data generated by onboard sensors of the vehicle;
receiving supplemental data generated by at least one source external to the vehicle;
processing the perception data and the supplemental data using a co-simulation process for simulating an environment of the vehicle; and
providing results of the co-simulation process to a remote assistance (RA) service;
wherein the results of the co-simulation process are used by the RA service to determine an RA response.

2. The method of claim 1, wherein the vehicle comprises a first vehicle and the perception data comprises first perception data, the method further comprising receiving second perception data generated by onboard sensors of a second vehicle proximate the first vehicle.

3. The method of claim 2, wherein the second perception data is also processed using the co-simulation process for simulating the environment of the first vehicle.

4. The method of claim 1, wherein the perception data comprises at least one of camera data, light detection and ranging (LIDAR) data, radio detection and ranging (RADAR) data, inertial measurement unit (IMU) data, and global positioning system (GPS) data.

5. The method of claim 1, wherein the supplemental data comprises at least one of traffic information, traffic signal information, weather information, vulnerable road user (VRU) information, emergency information, mapping information, and legal information.

6. The method of claim 1, wherein the RA response comprises redirecting the vehicle.

7. The method of claim 1, wherein the RA response comprises initiating a vehicle recovery event (VRE).

8. The method of claim 1, wherein the RA response comprises predicting a time at which the vehicle can be redirected.

9. The method of claim 1, further comprising advising a passenger of the vehicle of the RA response.

10. The method of claim 1, wherein the RA service comprises a human operator.

11. The method of claim 1, wherein results of the co-simulation process comprise a ranked list of options.

12. The method of claim 1, wherein the ranked list of options comprises, for each of the options, a confidence score associated with the option.

13. A method for providing a remote assistance (RA) response to an autonomous vehicle (AV) subsequent to a determination that the AV is stuck, the method comprising:
receiving by an RA service a plurality of possible options for the RA response, wherein the plurality of possible options for the RA response are determined by a co-simulation process that processes perception data generated by onboard sensors of the AV and AV supplemental data obtained from at least one source external to the AV to simulate operation of the AV;
selecting by the RA service one of the plurality of possible options for the RA response; and
directing the AV to operate in accordance with the selected one of the plurality of possible options, wherein each of the plurality of possible options has associated therewith a confidence score.

14. The method of claim 13, wherein the supplemental data comprises perception data generated by onboard sensors of another vehicle proximate the AV.

15. The method of claim 13, wherein the perception data comprises at least one of camera data, light detection and ranging (LIDAR) data, radio detection and ranging (RADAR) data, inertial measurement unit (IMU) data, and global positioning system (GPS) data.

16. The method of claim 13, wherein the supplemental data comprises at least one of traffic information, traffic signal information, weather information, vulnerable road user (VRU) information, emergency information, mapping information, and legal information.

17. The method of claim 13, wherein the selected one of the plurality of possible options comprises redirecting the AV, initiating a vehicle recovery event (VRE), and predicting a time at which the AV can be redirected.

18. The method of claim 13, further comprising advising a passenger of the AV of the selected one of the plurality of responses.

19. A non-transitory computer-readable medium having stored thereon instructions that, when executed by a processor of a computer, cause the computer to:
process perception data generated by onboard sensors of the vehicle and supplemental data received from at least one source external to the vehicle using a co-simulation process for simulating an operation of the vehicle in real-time;
provide results of the co-simulation process to a remote assistance (RA) service, wherein the RA service selects an RA response from the results; and
directing the vehicle to implement the RA response;
wherein the onboard sensors comprise at least one of a camera, a light detection and ranging (LIDAR) sensor, a radio detection and ranging (RADAR) sensor, an inertial measurement unit (IMU) sensor, and a global positioning system (GPS); and
wherein the supplemental data comprises at least one of perception data generated by onboard sensors of another vehicle proximate the vehicle, traffic information, traffic signal information, weather information, vulnerable road user (VRU) information, emergency information, mapping information, and legal information.

20. The non-transitory computer-readable medium of claim 19, wherein the RA response comprises redirecting the vehicle, initiating a vehicle recovery event (VRE), or predicting a time at which the vehicle can be redirected.
